(19) United States
(12) Patent Application Publication
(10) Pub. No.: US 2011/0187061 A1
(43) Pub. Date: Aug. 4, 2011

(54) STATIC SEALING DEVICE FOR LARGE-DIAMETER FLANGE WITH MAGNETIC FLUID SEAL

(75) Inventors: Decai Li, Beijing (CN); Zhenhua Feng, Beijing (CN)

(73) Assignee: Beijing Jiaotong University

(21) Appl. No.: 13/005,620

(22) Filed: Jan. 13, 2011

(30) Foreign Application Priority Data
Feb. 3, 2010 (CN) 201010104967.6

(51) Int. Cl. F16J 15/53

(52) U.S. Cl. 277/629

(57) ABSTRACT

A static sealing device for a large-diameter flange with magnetic fluid seal is provided, the device includes a left flange, magnets, a right flange, a large non-magnetic ring, a small non-magnetic ring, screws, bolts, nuts and washers. The large non-magnetic ring (4) is welded into the annular groove of the left flange (1) when installing, the small non-magnetic ring (5) is welded in the deep-hole of the left flange (1), the large non-magnetic ring (4) and small non-magnetic ring (5) are grinded, then bolts (7), washers (8) and nuts (9) are used to fix the left flange (1) and the right flange (3) together, then magnets (2) are embedded in the circumferential space between the left flange (1) and the right flange (2), a magnetic fluid is injected into the gap between the pole teeth of the left flange (1) and the right flange (3) through filling ports, filling ports are screwed into screws (6), so as to form the magnetic fluid seal. This device can be easily assembled in a very short time and has a high seal pressure capability, and a long service life.

### FIELD OF THE PRESENT INVENTION

The present invention is related to a static sealing device for a large diameter flange with a magnetic fluid seal, which belongs to the field of mechanical engineering seal.

### BACKGROUND OF THE PRESENT INVENTION

The magnetic fluid is a new functional material, it not only has the mobility of the liquid, but also has the magnetic properties of the traditional magnetic materials. The magnetic fluid seal is one of the most successful applications of the magnetic fluid, now it has been widely used in vacuum sealing. Currently, the vacuum seals for a large-diameter flange are mainly rubber seal, metal seal, and magnetic fluid seal, among which the ideal one is the magnetic fluid seal. Existing sealing device for a large-diameter flange with a magnetic fluid seal cannot be adjusted the size of seal gap evenly, and the traditional way of injecting magnetic fluid results in the uneven distribution of magnetic fluid in the gap and low seal pressure capability, and when the seal pressure is large, the structure becomes complex.

### SUMMARY OF THE PRESENT INVENTION

The object of the invention is to provide a static sealing device for a large diameter flange with a magnetic fluid seal, so as to overcome several disadvantages of the conventional large-diameter flange vacuum seal, such as low reliability, long assembly time, and low sealing pressure capability.

Technical solutions of the invention are as follows.

A static sealing device for a large diameter flange with a magnetic fluid seal is provided, and the device includes a left flange, magnets, a right flange, a large non-magnetic ring, a small non-magnetic ring, screws, bolts, nuts, and washers.

The large non-magnetic ring is welded into the annular groove of the left flange when installing, the small non-magnetic ring is welded into the right side deep-hole of the left flange, then the large non-magnetic ring and the small non-magnetic ring are grinded to insure the size of the gap between the pole teeth of the left flange and the right flange, bolts, washers and nuts are used to fix the left flange and the right flange together, then magnets are embedded in the circumferential space between the left flange and the right flange, finally a magnetic fluid is injected into the gap between the pole teeth of the left flange and the right flange through filling ports, the filling ports are screwed into screws, the magnetic fluid is attracted in the seal gap under the influence of the magnetic field, so as to form the magnetic fluid seal.

In order to ensure a consistency of the seal gap and uniform distribution of magnetic fluid in the seal gap, the thickness of the large non-magnetic ring and the small non-magnetic ring is with a margin, so it is possible to grind the large non-magnetic ring and the small non-magnetic ring to be the required size after welding the large non-magnetic ring and small non-magnetic ring with the left flange together, which brings in even contact between non-magnetic rings and the end-face of the right flange.

The magnet is consisted of N pieces of cylindrical magnets. Two end-faces of each magnet and the location of the left flange and the right flange where magnets are installed are both designed with a 1 degree of slope, interference fit is used between single magnet and two flanges.

The diameter d of single magnet is 50 mm-120 mm, the magnets are spaced out evenly between the left flange and the right flange; the number N of magnets is determined by the distance R between the center of a single magnet and the center of left and right flanges, the circumferential pitch L between magnets, and the diameter d of a single magnet; the number

$$N \approx \frac{2 π R}{L + d} .$$

Filling ports are provided on the right flange, three filling ports are spaced out evenly along radial positions that correspond with tooth socket of the pole teeth, six identical filling ports are laid out evenly on the circumference in which the centerline of each filling port is lied.

As the beneficial effects of the invention, since two end-faces of each magnet and the location of the left flange and the right flange where magnets are installed are both designed with a 1 degree of slope, the magnets can be easily assembled together in a very short time; the size of the seal gap can be easily adjusted and ensured consistency because two non-magnetic rings are provided, and the magnetic fluid is injected into the gap between the pole teeth of the left flange and the right flange through the filling port, this method of injecting can make the magnetic fluid to be uniformly distributed in the seal gap, which can improve seal pressure capability and extend the service life of the sealing device.

### DESCRIPTION OF THE ACCOMPANYING DRAWINGS

FIG. 1 is the schematic structural view of the static sealing device for the large-diameter flange by means of magnetic fluid.

FIG. 2 is the A-A sectional view of the device.

FIG. 3 is the right elevation of the static sealing device for the large-diameter flange by means of magnetic fluid.

FIG. 4 is the drawing of partial I enlargement.

FIG. 5 is the drawing of partial II enlargement.

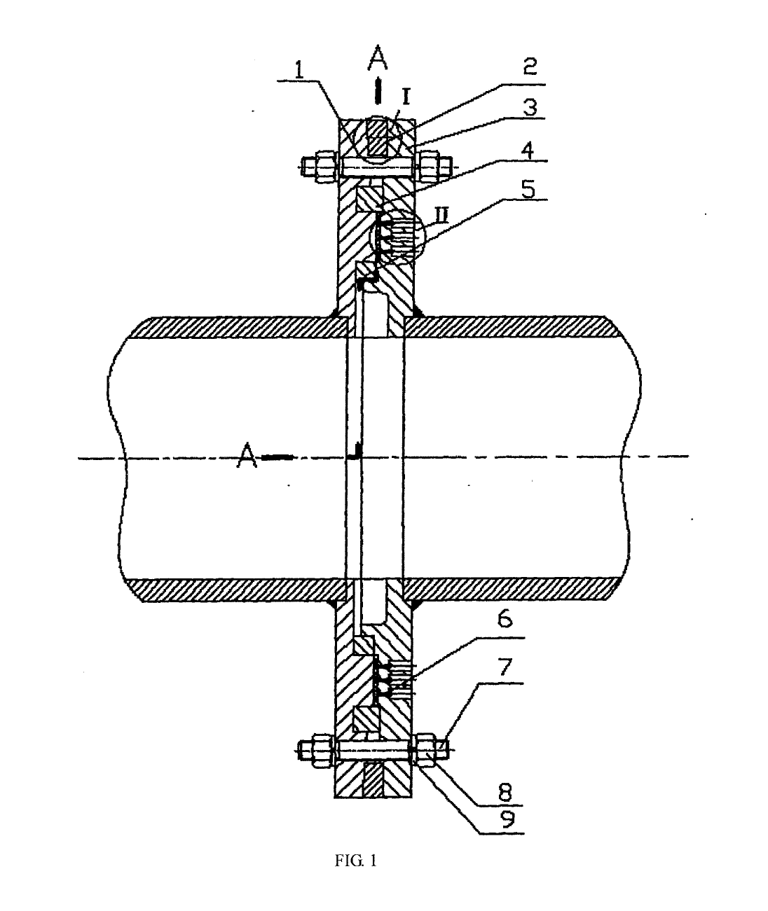

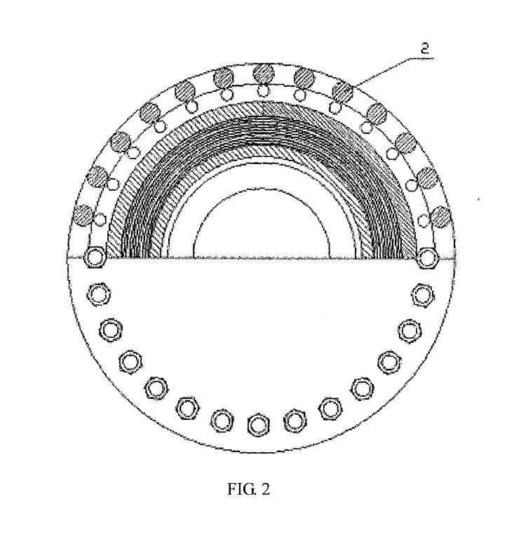

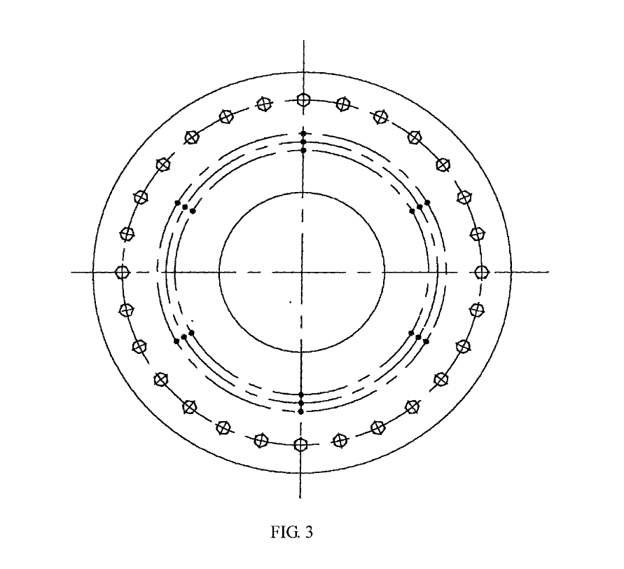

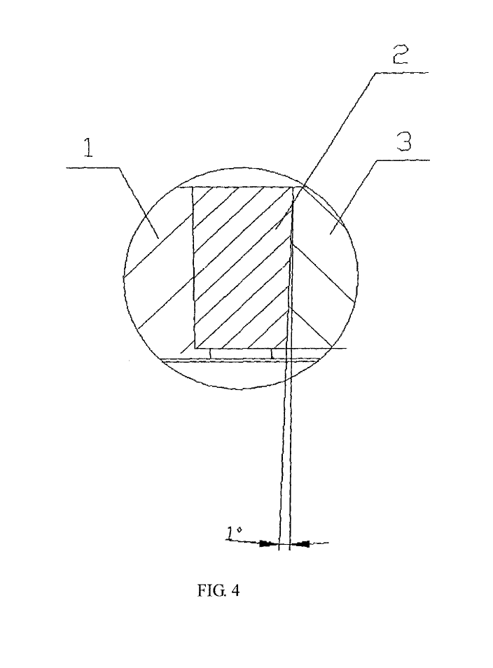

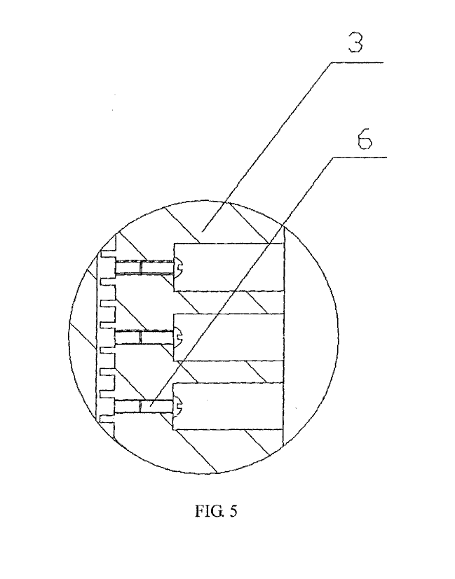

In the FIGS. 1-5, there are shown a left flange 1, magnets 2, a right flange 3, a large non-magnetic ring 4, a small non-magnetic ring 5, a plurality of screws 6, a plurality of bolts 7, a plurality of nuts 8, and a plurality of washers 9.

### BEST MODE FOR CARRYING OUT THE PRESENT INVENTION

With for the accompanying drawings, further description of the invention will be made as follows.

The static sealing device for a large-diameter flange by means of magnetic fluid includes a left flange 1, magnets 2, a right flange 3, a large non-magnetic ring 4, a small non-magnetic ring 5, a plurality of screws 6, a plurality of bolts 7, a plurality of nuts 8, and a plurality of washers 9.

The large non-magnetic ring 4 is welded into the annular groove of the left flange 1 when installing, the small non-magnetic ring 5 is welded into the right deep-hole of the left flange 1, then the large non-magnetic ring 4 and small non-magnetic ring 5 are grinded to insure the size of the gap between the pole teeth of the left flange 1 and the right flange 3, then the bolts 7, the washers 8 and the nuts 9 are used to fix the left flange 1 and the right flange 3 together, then the magnets 2 are embedded in the circumferential space between the left flange 1 and the right flange 2, finally a magnetic fluid is injected into the gap between the pole teeth of the left flange 1 and the right flange 3 through 18 filling ports, 18 corresponding screws 6 are screwed into filling ports, so the magnetic fluid is attracted in the seal gap under the influence of the magnetic field, so as to form the magnetic fluid seal.

To make the left flange 1 and the right flange 3 tightly fit together evenly and to guarantee the uniform size of the seal gap, the bolts 7 should be evenly arranged along the circumference, which can make sealing function along circumferential direction in consistency, in addition, when there is pressure in the seal gap, the left flange 1 and the right flange 3 can still bond tightly.

The magnet 2 is composed of N pieces cylindrical magnets. The diameter d of any single magnet is 50 mm-120 mm. If the diameter of the cylindrical magnet is too small, it will take a long time to do assembly, and if the diameter of any cylindrical magnet is too large, the interaction between the magnet 2 and the left flange 1, and the right flange 3 will be very strong in magnetic force, which causes difficulty of assembly, the magnets are spaced out evenly between the left flange and the right flange; the number of magnets N is determined by the distance R between the center of a single magnet and the center of flanges, the circumferential space L between the magnets and the diameter d of single magnet; the number

$$N \approx \frac{2 π R}{L + d} .$$

1. A static sealing device for a large-diameter flange with magnetic fluid seal, the device includes a left flange, N pieces of cylindrical magnets, a right flange, a plurality of bolts, a plurality of nuts, and a plurality of washers; bolts, nuts and washers are used to fix the left flange and the right flange together; the magnetic fluid is injected into the gap between the pole teeth of the left flange and the right flange; and N pieces of cylindrical magnets are embedded in the circumferential space between the left flange and the right flange, so as to form the magnetic fluid seal,
characterized in that
the large non-magnetic ring (4) is welded into the annular groove of the left flange (1), the small non-magnetic ring (5) is welded into the right side deep-hole of left flange (1), the large non-magnetic ring (4) and the small non-magnetic ring (5) are grinded to insure the size of the gap between the pole teeth of the left flange (1) and the right flange (3);
a magnetic fluid is injected into the gap between the pole teeth of the left flange (1) and the right flange (3) through filling ports, filling ports are screwed into screws (6).

2. The static sealing device for a large-diameter flange with magnetic fluid seal as described in claim 1, characterized in that the diameter d of a single magnet is 50 mm-120 mm, the magnets are spaced out evenly between the left flange and the right flange, the number N of magnets is determined by the distance R between the center of the magnet and the center of left and right flange, the circumferential pitch L between magnets, and the diameter d of a single magnet, the number
$$N \approx \frac{2 π R}{L + d} .$$

3. The static sealing device for a large-diameter flange with magnetic fluid seal as described in claim 1, characterized in that the location of the left flange (1) and the right flange (3) where the magnets are installed and the end-face of each magnet are both designed to be with a 1 degree of slope; the magnet (2) is in interference fit with the left flange (1) and the right flange (3).

4. The static sealing device for a large-diameter flange with magnetic fluid seal as described in claim 1, characterized in that the filling ports are provided on the right flange (3), three filling ports are spaced out along radial positions that correspond with tooth socket, six identical filling ports are laid out evenly on the circumference in which the centerline of each filling port is lied.
